(19) United States
(12) Patent Application Publication
(10) Pub. No.: US 2005/0284715 A1
(43) Pub. Date: Dec. 29, 2005

(54) Hydraulic shock absorber

(75) Inventors: Akira Kojima, Inuyama (JP); Takahiro Niwa, Inuyama (JP)

Correspondence Address: BROWDY AND NEIMARK, P.L.L.C.;624 NINTH STREET, NW, SUITE 300, WASHINGTON, DC, 20001-5303, US

(73) Assignee: Daido Metal Co. Ltd., Nagoya (JP)

(21) Appl. No.: 11/156,598

(22) Filed: Jun. 21, 2005

(30) Foreign Application Priority Data
Jun. 23, 2004 (JP) 2004-184977

(51) Int. Cl. F16F 9/00

(52) U.S. Cl. 188/322.19

(57) ABSTRACT

A hydraulic shock absorber in which a sliding member in a location far from an opening portion of an external cylinder is fixed on an inner peripheral surface of the external cylinder with extremely simple structure is provided. A sliding member fittingly fixed in the location far from the opening portion is formed in a ring shape at a parting line gap angle of 15° to 25°, and is deformed to reduce the parting line gap angle during press-fitting operation into the external cylinder so as to be fitted and assembled in a fitting recess formed on an external cylinder inner peripheral surface in the location far from the opening portion. Accordingly, a space of the opening is formed relatively wide and thus, it is possible to press-fit the sliding member in the location far from the opening portion by sufficiently deforming the sliding member.

### BACKGROUND OF THE INVENTION

1. Field of the Invention

The present invention relates to a hydraulic shock absorber in which a rod or an internal cylinder is contacted on sliding members fittingly fixed at two upper and lower places on an inner peripheral surface of an external cylinder, so as to be slidable thereon.

2. Description of the Prior Art

In a convention hydraulic shock absorber, a rod or an internal cylinder is made slidable on an external cylinder by disposing therebetween ring-shaped sliding members such as a bush in an upper and lower direction of the external cylinder. In this case, since the external cylinder is generally formed in a bottomed shape, a distance for press-fitting the sliding member of a ring-shape from an opening portion of the external cylinder is long, so that the sliding member disposed in a location far from the opening portion of the external cylinder may damage an inner wall surface of the external cylinder during the press-fitting operation. Accordingly, the sliding member in the location far from the opening portion of the external cylinder is fixed on an outer peripheral surface of the rod or the internal cylinder. On the contrary, the sliding member disposed in a location near the opening portion of the external cylinder is fixed on an inner peripheral surface of the external cylinder since a distance for press-fitting the sliding member from the opening portion of the external cylinder is short.

In the hydraulic shock absorber configured as described in the above, a sliding surface of the sliding member disposed in the location near the opening portion of the external cylinder slides on the outer peripheral surface of the rod or the internal cylinder, and a sliding surface of the sliding member disposed in the location far from the opening portion of the external cylinder slides on the inner peripheral surface of the external cylinder. Accordingly, the surface roughness of the outer peripheral surface of the rod or the internal cylinder and the inner peripheral surface of the external cylinder, which surfaces slide on the two sliding members, significantly affects the amount of wear. However, the external cylinder particularly has a defect that it is difficult to finely process the surface roughness of the inner peripheral surface of the external cylinder, since the external cylinder is formed in the bottomed shape as described in the above.

In order to remove the defect as described in the above, it can be considered to provide the structure in which the two sliding members are fixed on the inner peripheral surface of the external cylinder, so that the sliding surfaces of the sliding members slide on the outer peripheral surface of the rod or the internal cylinder, since the surface roughness of the outer peripheral surface is readily made fine. JP-A-2000-179603 shows such structure (see Paragraph 0013, and reference numerals 4 and 5 in FIG. 1).

### BRIEF SUMMARY OF THE INVENTION

Although JP-A-2000-179603 discloses that a sliding member (bush 4) disposed in a location far from an opening portion of an external cylinder (outer tube 29) is fixed on an inner peripheral surface of the external cylinder, it does not disclose how (or by which structure) the sliding member is fixed to the external cylinder, at all. The present invention is made in view of the above situation, and an object thereof is to provide a hydraulic shock absorber in which a sliding member in a location far from an opening portion of an external cylinder can be fixed on an inner peripheral surface of the external cylinder with extremely simple structure.

According to a first aspect of the invention, there is provided a hydraulic shock absorber in which a rod or an internal cylinder is contacted on sliding members fittingly fixed at two upper and lower places on an inner peripheral surface of an external cylinder so as to be slidable thereon, characterized in that at least the sliding member fittingly-fixed in a location far from an opening portion of the external cylinder is formed in a ring shape at a parting line gap angle of 15° to 25°, and is deformed to reduce the parting line gap angle during press-fitting operation into the external cylinder so as to be fitted and assembled in a fitting recess formed on the external cylinder inner peripheral surface in the location far from the opening portion of the external cylinder.

Further, according to a second aspect of the invention, the sliding members are characterized by providing a resin layer on an inner peripheral surface of a steel back metal. According to a third aspect of the invention, the sliding member is characterized by providing a cupper-based or aluminum-based bearing alloy layer on an inner peripheral surface of a steel back metal.

In the present invention, since the sliding member fittingly-fixed in a location far from an opening portion of the external cylinder is formed in the ring shape at a parting line gap angle of 15° to 25°, and is deformed to reduce the parting line gap angle during the press-fitting operation into the external cylinder so as to be fitted and assembled in the fitting recess formed on the external cylinder inner peripheral surface in the location far from the opening portion of the external cylinder, a space of the opening is formed relatively wide and thus it is possible to press-fit the sliding member in the location far from the opening portion of the external cylinder by sufficiently deforming the sliding member. In this case, if the parting line gap angle is less than 15°, the sufficient deformation can not be obtained during the press-fitting operation into the external cylinder and thus, the inner peripheral surface of the external cylinder or the sliding member itself may be damaged during the press-fitting operation. Also, if the parting line gap angle is more than 25°, the space of the opening becomes wide after the press-fitting operation and thus, a gap between the sliding member and the rod or the internal cylinder becomes large, with the result that smooth sliding may not be performed. Further, it is desirable that the sliding member is a sliding member using a steel back metal with rigidity as a back metal to ensure the deformation during the press-fitting operation and the recovery after the press-fitting operation.

Hereinafter, an embodiment of the present invention will be explained with reference to the drawings.

### BRIEF DESCRIPTION OF THE SEVERAL VIEWS OF THE DRAWINGS

FIG. 1 is a typical view of a hydraulic shock absorber according to an embodiment of the present invention; and

FIG. 2 is a front view of a sliding member fixed in the hydraulic shock absorber.

### DETAILED DESCRIPTION OF THE INVENTION

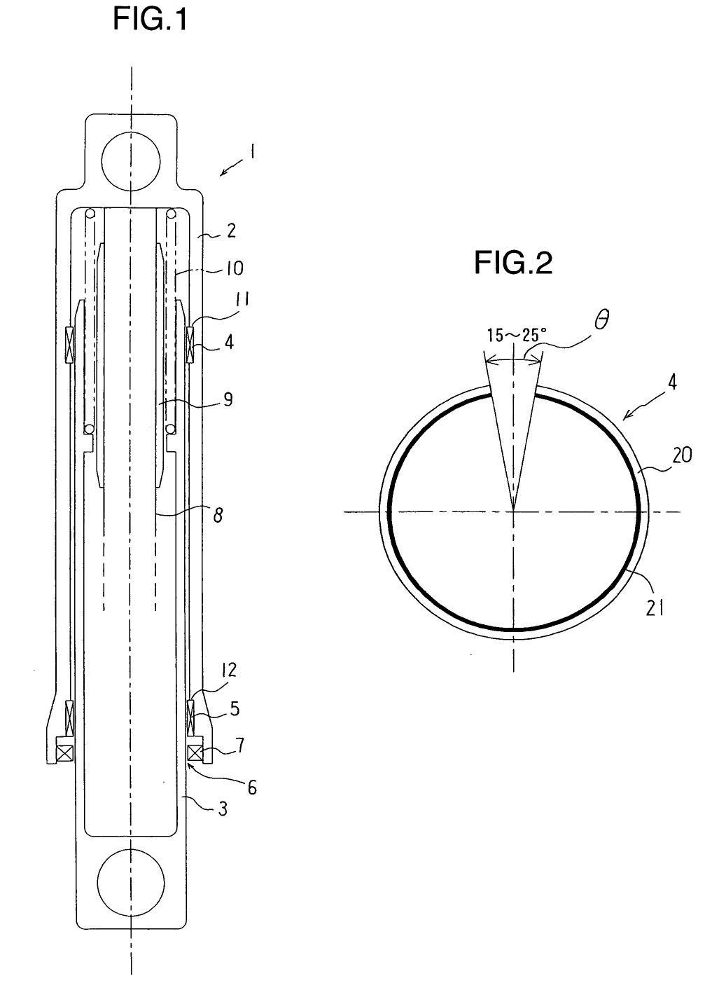

FIG. 1 is a typical view showing a hydraulic shock absorber, and FIG. 2 is a front view of a sliding member. In FIG. 1, a hydraulic shock absorber 1 is a typical view of a front fork for a two-wheeled vehicle, in which an internal cylinder 3 to be mounted on an axle side is slidably inserted in an external cylinder 2 to be mounted on a vehicle body side. Ring-like-shaped sliding members 4 and 5 are fixed in fitting recesses 11 and 12 formed on an inner peripheral surface of the external cylinder 2, and are adapted to slide on an outer peripheral surface of the internal cylinder 3. Further, an oil seal member 7 for sealing the interior of the external cylinder 2 and the internal cylinder 3 is provided on an inner periphery in an opening portion 6 of the external cylinder 2.

Further, a damper 8 (not shown in detail) consisting of a damper cylinder and a piston rod is equipped within the interior of the external cylinder 2 and the internal cylinder 3. The damper 8 is configured to absorb shock by adjusting pressure in a gas chamber and an oil chamber in the damper 8 in accordance with sliding between the external cylinder 2 and the internal cylinder 3. Also, as structure for absorbing the shock due to the sliding between the external cylinder 2 and the internal cylinder 3, there is a spring 10 disposed in an upper portion in the inside of the internal cylinder 3 but outside the damper 8, an upper end of which spring 10 is contacted with a bottomed surface of the external cylinder 2, a lower end of which spring 10 is contacted with a spring lock formed in the internal cylinder 3. Further, a spring guide 9 is fixed to the outside of the damper 8 for guiding the expansion and contraction of the spring 10. As described in the above, the hydraulic shock absorber 1 shown in the drawing has the structure in which the shock is absorbed by the damper 8 and the spring 10.

For the meanwhile, while the external cylinder 2 and the internal cylinder 3 of the hydraulic shock absorber are made slidable by the sliding members 4 and 5 fittingly fixed in the fitting recesses 11 and 12 formed in upper and lower places on the inner peripheral surface of the external cylinder 2 as described in the above, the sliding member 4 particularly has the structure as shown in FIG. 2 to press-fit the sliding member 4, to be fitted in the fitting recess 11 in a location far from the opening portion 6 of the external cylinder 2, from the opening portion 6 of the external cylinder 2.

Namely, the sliding member 4 is formed by laminating a sliding layer 1 consisting of a resin sliding layer obtained by impregnating a porous cupper-based alloy with a resin layer (three-layer structure), a cupper-based or aluminum-based bearing alloy (two-layer structure), or the like, on an inner peripheral surface of a steel back metal 20, and is designed so that its parting line gap angle θ is between 15° and 25°. Conventionally, a joint portion of a ring-like-shaped sliding member has been generally designed so that its space becomes zero after press-fitting. However, in the present embodiment, in order to prevent the inner peripheral surface of the external cylinder and the sliding member 4 itself from being damaged when moving it to the location far from the opening portion 6 of the external cylinder 2 during the press-fitting to the external cylinder 2, the width of the joint portion is designed so that the space of the joint portion is not zero even after the press-fitting. It is confirmed that the sliding between the external cylinder 2 and the internal cylinder 3 is performed smoothly, even if the space of the joint portion is not zero after the press-fitting. However, if the parting line gap angle θ is less than 15°, it becomes impossible to obtain sufficient deformation for press-fitting the sliding member 4 into the external cylinder 2, with the result that the inner peripheral surface of the external cylinder 2 or the sliding member 4 itself may be damaged during the press-fitting. Also, if the parting line gap angle θ is beyond 25°, the space after the press-fitting becomes wide, with the result that a gap between the sliding member and the internal cylinder 3 becomes large, so that smooth sliding may not be performed. Accordingly, it is preferable that the parting line gap angle θ is designed to between 15° and 25°. Further, as structure of the sliding material 5 fixed in a location near the opening portion 6 of the external cylinder 2, it may be the same structure as the sliding member shown in FIG. 2, or a conventional sliding member in which a space becomes zero after the press-fitting may be used.

While the above description is made concerning the structure of the hydraulic shock absorber 1 according to the embodiment, the hydraulic shock absorber 1 shown in the drawing is described using an example of a shock absorber for a two-wheeled vehicle in which the external cylinder 2 and the internal cylinder 3 slide on each other. Beside the hydraulic shock absorber 1 can be applied to a hydraulic shock absorber such as a shock absorber for a four-wheeled vehicle in which an external cylinder and a piston rod slide on each other. Further, while the description is made concerning a sliding member having a steel back metal since a certain degree of rigidity is necessary as the sliding member 4, if a certain degree of rigidity can be assured, it may be a solid sliding member consisting only of a sliding material, or a sliding member in which a reinforcing material is insert-molded with a sliding resin.

The above described description is made concerning the one embodiment, but the present invention is not limited to these, and it is obvious to those skilled in the art to be able to make various changes and corrections within the spirit of the present invention and the scope of the attached claims.

1. A hydraulic shock absorber comprising:
an external cylinder having an opened end and a closed end;
two sliding members fittingly fixed at two places on an inner peripheral surface of the external cylinder, so that the two sliding members being located on an opened end side and a closed end side in the axial direction of the external cylinder, respectively; and
a rod or an internal cylinder contacted on the two sliding members so as to be slidable thereon, wherein
at least the sliding member on the closed end side of the external cylinder is formed in a ring shape having an opening in the axial direction thereof at a gap angle of 15° to 25°, and is deformed to reduce the gap angle during press-fitting operation into the external cylinder so as to be fitted and assembled in a fitting recess formed at the place on the closed end side on the inner peripheral surface of the external cylinder.

2. The hydraulic shock absorber according to claim 1, wherein the sliding members comprise a steel back metal and a resin layer provided on an inner peripheral surface of the steel back metal.

3. The hydraulic shock absorber according to claim 1, wherein the sliding members comprise a steel back metal and a cupper-based or aluminum-based bearing alloy layer provided on an inner peripheral surface of the steel back metal.
